(19) United States
(12) Patent Application Publication
(10) Pub. No.: US 2022/0059966 A1
(43) Pub. Date: Feb. 24, 2022

(54) Protective Apparatus for Electrical Plug Connections

(71) Applicant: Imad Michael Birouty, San Diego, CA (US)

(72) Inventor: Imad Michael Birouty, San Diego, CA (US)

(21) Appl. No.: 16/998,439

(22) Filed: Aug. 20, 2020

(51) Int. Cl. H01R 13/52; H01R 13/447

(52) U.S. Cl. CPC H01R 13/521; H01R 13/5216; H01R 13/5219; H01R 13/447

(57) ABSTRACT

A protective insert fits between a plug and a power outlet or another plug and is designed to undergo elastic deformation when pressed between a plug and a power outlet, or between a male plug and a female plug, filling the space between the plug and the power outlet, or between the plugs. As a result, open pockets or pathways between the plugs or the plug and the power outlet that would allow for the entry of moisture are avoided, being filled by the insert. The insert has a body made of a suitably soft material to undergo elastic deformation between a plug and a power outlet or another plug, and two or three apertures with placement and size to allow the insert to fit around the prongs on the face of a plug.

### FIELD OF THE INVENTION

The present invention pertains generally to protective apparatus for electrical connections. More particularly, the present invention pertains to an apparatus that provides weatherproofing for a connection between plugs or between a plug and an electrical outlet.

### BACKGROUND OF THE INVENTION

Electric power began to be available to the public in the 1880s. Since that time, the public has been aware of both the benefits and the dangers of electricity, including the dangers and problems posed by moisture to an electrical connection or to electronic equipment. So well known are the dangers of mixing water and electricity that they have become a recurring gag in popular culture, including in comedy films and television.

As electrical power became widely available, so did outdoor uses of electricity—and mains power in particular—in which the presence of moisture, e.g. through dew or rain, presents a problem. By the early 1900s, holiday displays with electric lights, such as lighted Christmas trees, were common; by the mid-1900s, the exteriors of private homes were regularly illuminated by colorful electric lights during the holidays. Other outdoor uses of mains power with histories spanning decades include speaker systems and exterior lighting for parties and concerts, electric lawnmowers, and pool and spa heaters, among many other uses.

Fuses and circuit breakers are common protective devices that have been in use since the late 1800s. Fuses, circuit breakers, and ground-fault circuit interrupters (GCFIs) provide some protection against potentially dangerous situations, including short circuits caused by moisture, by interrupting current flow in the event of excess current, or in the case of a GCFI, a current leak. These types of protective devices therefore shut off the supply of electricity after a problem occurs, rather than preventing the problem in the first place.

Attempts have been made to protect electrical connections from exposure to moisture through the use of weather-resistant covers, which have been available for decades. The simplest outlet covers only cover an outdoor electrical outlet; when the outlet is in use, the cover is open and does not provide any protection against moisture. One type of cover is needed to protect a connection between a plug and an outlet, and a separate type of cover is needed to protect a connection between two plugs, such as when two extension cords are plugged together or when an extension cord is plugged into an electric lawnmower. The covers that protect a connection between a plug and an outlet require removal of the existing outlet cover and installation of the new one.

Larger outlet covers and extension cord covers that cover a plug during use have only gained limited acceptance due in part to the awkwardness of creating a bulky shell around the connection. Moreover, the size of outlet covers and extension cord covers can render them unsuitable for certain indoor uses in which moisture poses a problem, such as in bathrooms and kitchens.

In light of the above, it would be advantageous to provide a protective apparatus that protects an electrical connection from exposure to moisture. It would be further advantageous to provide an apparatus that provides moisture protection for a connection between a plug and an outlet and for a connection between two plugs. It would be further advantageous to provide an apparatus that provides moisture protection for an electrical connection without requiring a shell or cover over the connection.

### SUMMARY OF THE INVENTION

Disclosed is a protective insert that fits between a plug and a mains power source, such as a power outlet or another plug. “Mains power source,” as used herein refers to a source of mains power, such as an electrical socket on or in a building, including indirect sources such as extension cords that do not use transformers to alter the voltage away from the nominal voltage of the mains power or rectifiers to change the provided current from alternating current (AC) to direct current (DC). Sources that provide a practical equivalent to a mains power source, such as generators, are contemplated to be within the meaning of “mains power source” as used herein.

Preferred embodiments of the insert are designed to undergo elastic deformation when pressed between a plug and a power outlet, or between a male plug and a female plug, filling the space between the plug and the power outlet, or between the plugs. As a result, open pockets or pathways between the plugs or the plug and the power outlet that would allow for the entry of moisture are avoided, being filled by the insert.

Preferred embodiments of the insert have a body made of a suitably soft material to undergo elastic deformation between a plug and a mains power source, and two or three apertures with placement and size to allow the insert to fit around the prongs on the face of a plug. The body is “insulating,” meaning herein that it is an electrical insulator, and impermeable to water, meaning that water does not penetrate through its surface. One suitable material that provides these characteristics and from which some preferred embodiments of the insert are made is thermoplastic rubber (TPR). It will be apparent to one of ordinary skill in the art that other materials would also be appropriate for making the insert, including some other polymers, copolymers, polymer blends, and rubbers, among other materials; embodiments made with such materials are fully contemplated herein. The insert can be made through extrusion, injection molding, 3D-printing, or other manufacturing processes suitable for the material chosen.

In preferred embodiments of the insert, the body has a flat cylindrical shape, with circular faces having two or three apertures that extend through the body from one face or surface to the other. The body is sufficiently thin, or in other words, the cylinder is sufficiently flat, that an unimpaired electrical connection can be made between a plug and a mains power source while the insert is located between the plug and the mains power source. An alternate embodiment has a single aperture large enough to fit around the prongs of a plug.

Preferred embodiments of the insert also have a diameter that results in the face of the body covering the entirety of the face of a typical plug. Due to the size of preferred embodiments of the insert, when the body undergoes elastic deformation while pressed between a plug and a mains power source, the body bulges out around the edges of the face of the plug, providing an additional barrier to the entry of water, and thus further protecting the electrical connection against moisture.

Another embodiment of a protective apparatus for electrical plug connections includes a plug with an insulating, water-impermeable material able to undergo elastic deformation between the plug and a mains power source. The insulating material is affixed to the face of the plug, meaning herein that it is permanently attached to the face of the plug, and functions substantially the same as the insert described above. The various features and materials of the various embodiments of the protective insert described herein are also present in different embodiments of the plug with the protective material attached to its face. In preferred embodiments, the protective material is shaped to match the face of the plug.

Another embodiment of a protective apparatus for electrical plug connections includes a socket with an insulating, water-impermeable material able to undergo elastic deformation between the socket and a plug. The insulating material is affixed to the face of the socket, and functions substantially the same as the insert described above. The various features and materials of the various embodiments of the protective insert described herein are also present in different embodiments of the socket with the protective material attached to its face. In preferred embodiments, the protective material is shaped to match the face of the socket.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates a duplex receptacle with outlet covers;

FIG. 2 illustrates a duplex receptacle with a receptacle cover;

FIG. 3 illustrates an extension cord cover;

FIG. 4 is a perspective view of a preferred embodiment of a protective insert for an electrical plug connection;

FIG. 5 is a diagram illustrating the use of the protective insert of FIG. 4 with a plug and an electrical socket;

FIG. 6 is a top perspective view of the protective insert of FIG. 4 in use between a plug and an electrical socket;

FIG. 7 is a diagram illustrating the use of the protective insert of FIG. 4 with two plugs;

FIG. 8 is a cross-sectional view of a plug being inserted into another plug with the protective insert of FIG. 4;

FIG. 9 is a cross-sectional view of a plug inserted into another plug with the protective insert of FIG. 4;

FIG. 10 is a perspective view of an alternate embodiment of a protective insert for an electrical plug connection; and

FIG. 11 is a perspective view of another alternate embodiment of a protective insert for an electrical plug connection.

### DETAILED DESCRIPTION

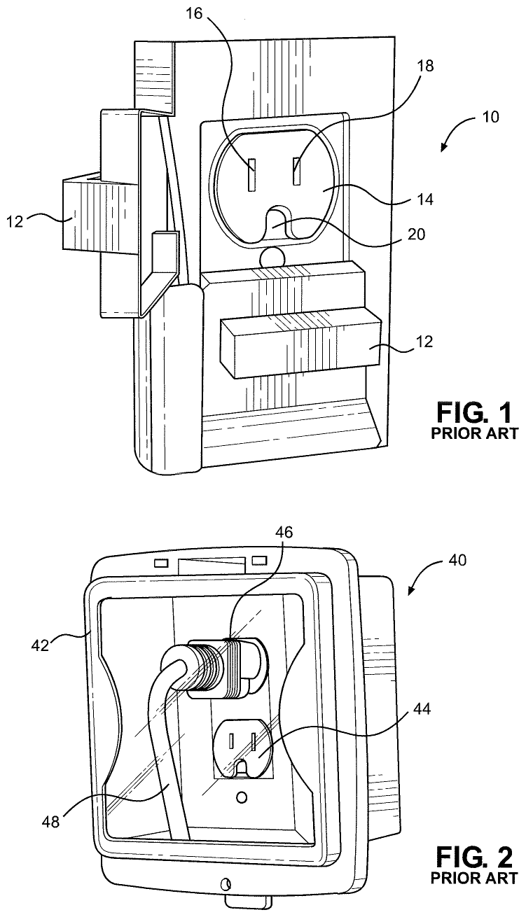

Referring initially to FIG. 1, outdoor receptacles 10 commonly have outlet covers 12 to protect outlets or sockets 14 from the weather. The electrical sockets 14 themselves provide electrical power through a voltage differential between a neutral line 16 and a “hot” line 18. The hot line 18 continuously swings between a peak positive voltage and a corresponding peak negative voltage difference from neutral line 16. The nominal voltage provided by the socket 14 is the root-mean-square (RMS) of the voltage provided over a full cycle of the hot line 18 from zero volts to positive peak, to negative peak, and back to zero; since the voltage swing of sockets 14 is usually sinusoidal, the root-mean-square is the peak voltage divided by the square root of two. In most sockets 14 in North America, the peak voltage is approximately one-hundred sixty-five (165) volts, resulting in an RMS value of about one-hundred twenty (120) volts. In other parts of the world, it is common for the peak voltage to be about three-hundred twenty-five (325) volts, resulting in an RMS value of about two-hundred thirty (230) volts.

In some cases, particularly with older sockets 14, a hot line 18 is not clearly distinguished from a neutral line 16, and it must be assumed that either line can be hot at any time.

In addition to a neutral line 16 and a hot line 18, modern sockets 14 usually include a safety ground 20 to provide an alternate path to ground that is generally expected not to carry return current from a device plugged into the socket 14.

Since natural water sources are generally good conductors of electricity, outdoor sockets 14 need to be protected from water to avoid risks such as short-circuits, fires, electrocution, or any other problems that may arise from the combination of moisture and an electrical power source. Outlet covers 12 provide a way to diminish the risk while sockets 14 are not in use, but since an outlet cover 12 must be opened in order to use the corresponding socket 14, they do not provide protection while socket 14 is being used.

Referring now to FIG. 2, a receptacle 40 with a receptacle cover 42 is illustrated. Receptacle cover 42 covers the sockets 44 of receptacle 40 as well as a plug 46 plugged into a socket 44. Cord 48 of plug 46 extends out of receptacle cover 42 through an opening (not illustrated) on the bottom of receptacle cover 42.

Limitations of receptacle cover 42 include its size: it needs to be large enough to cover the receptacle 40 and any plugs plugged into it. Moreover, installation of a receptacle cover 42 generally requires replacement of the entire receptacle 40, and thus can be a complicated and costly job requiring a qualified electrician. Another potential issue is that a receptacle cover 42 limits the plug size that can be used, since the receptacle must cover the entire plug. Thus, receptacle cover 42 is not suitable for use with certain power adapters that have large plugs. Moreover, receptacle cover 42 is only effective to protect wall-mounted power sources and cannot protect a plug plugged into an extension cord.

Referring now to FIG. 3, an extension cord cover 60 is illustrated. Extension cord cover 60 is a case 62 that is placed over a connection between two extension cords. More specifically, when the end of an extension cord 64 having a male plug 66 is plugged into a female plug 68 of another extension cord 72 in order to extend extension cord 72, the connection between male plug 66 and female plug 68 runs the same risks from water as a plug plugged into a socket. In order to mitigate those risks, case 62 of extension cord cover 60 covers the connected male plug 66 and female plug 68.

Due to the size of extension cord cover 60, which has to fit around the outside of plugs 66 and 68, extension cord cover 60 is not always an ideal solution. Moreover, its usefulness is effectively limited to connections between extension cords: it does not work with receptacles or large plugs such as power adapter plugs.

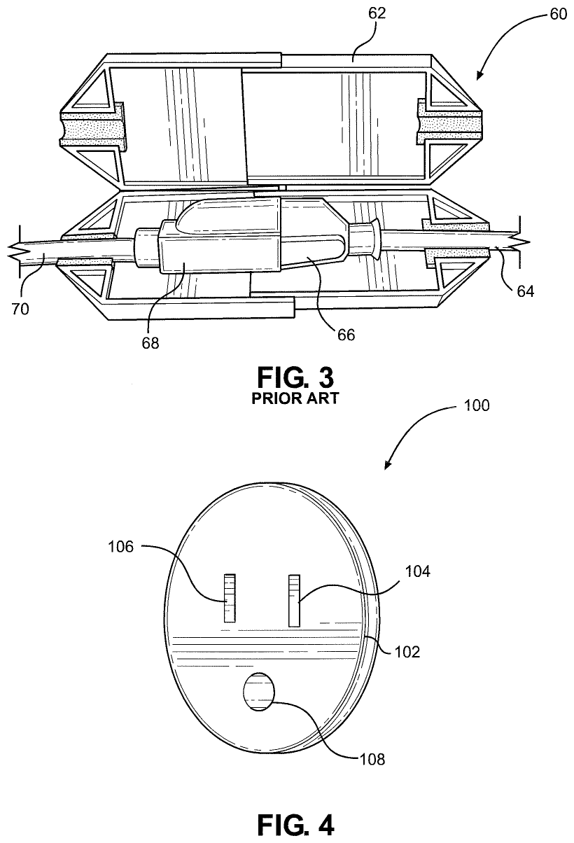

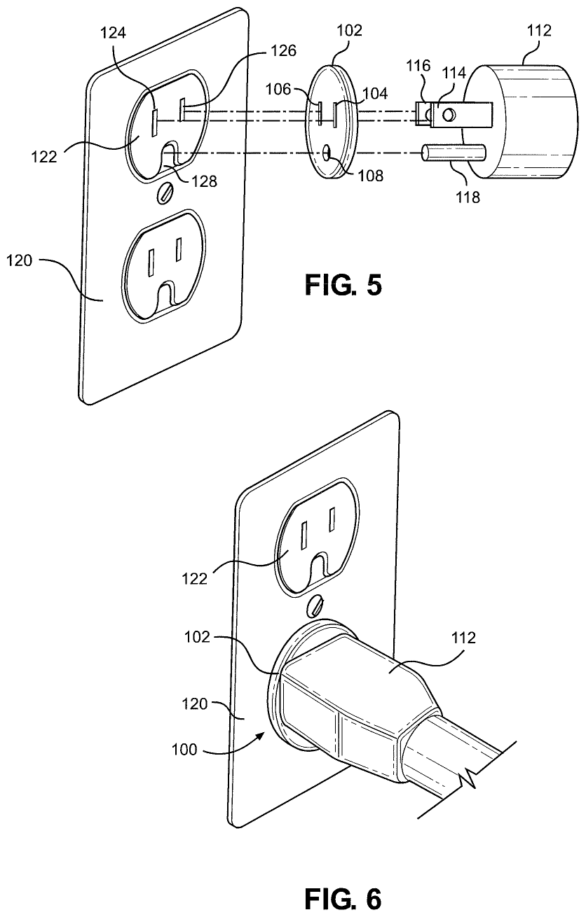

Referring now to FIG. 4, a preferred embodiment of a protective insert for an electrical plug connection is illustrated and generally designated 100. Insert 100 has a body 102 with apertures 104, 106, and 108 sized, shaped, and positioned to receive prongs of an electrical plug. Insert 100 is illustrated with three apertures 104, 106, and 108 for a North American style plug 112 (shown in FIG. 5) with a safety ground prong; however, embodiments of insert 100 with a number, size, shape, and position of apertures suitable for other plug types are fully contemplated herein. Moreover, preferred embodiments of insert 100 have a body 102 with a circular face, as illustrated. Nonetheless, it will be apparent to one of ordinary skill in the art that other shapes of body 102 are also possible, and embodiments with such shapes are fully contemplated.

Body 100 is made of an insulating material impermeable to water. Moreover, body 100 is sufficiently soft to undergo elastic deformation when placed between a plug and a power source, thus waterproofing the connection between the plug and the power source. A preferred embodiment of body 100 is made of thermoplastic rubber (TPR); an alternate embodiment is made of silicone. Additional embodiments use other insulating, water-impermeable, stretchable materials.

Referring now to FIG. 5, the use of insert 100 to protect a connection between a plug 112 and a socket 122 is illustrated. Socket 122 is shown as part of a duplex receptacle 120 for illustrative purposes; however, it will be apparent to one of ordinary skill in the art that insert 100 will function equally well with stand-alone sockets and with sockets in other receptacle types.

To use insert 100 to protect an electrical connection between a plug 112 and an electrical socket 122, prongs 114, 116, and 118 of plug 112 are passed through apertures 104, 106, and 108 of insert 100 and into lines 124, 126, and 128 of socket 122. More particularly, prong 114 passes through aperture 104, which is shaped and positioned to receive prong 114; prong 114 then enters the opening of socket 122 for neutral line 124, placing prong 114 in electrical communication with neutral line 124. Body 102 of insert 100 is sufficiently thin that it does not interfere with electrical communication between prong 114 and neutral line 124 or between prong 116 and hot line 126, or between ground prong 118 and ground line 128. More generally, preferred embodiments of body 102, which vary in the location, shape, and number of apertures so as to accommodate different plug types, are sufficiently thin so as to allow electrical connection between the prongs of a plug and an outlet.

Prong 116 passes through aperture 106, which is sized and positioned to receive prong 116. Prong 116 then enters the opening for hot line 126, placing prong 116 in electrical communication with hot line 126. Likewise, ground prong 118 passes through aperture 108, which is sized and positioned to receive ground prong 118. Prong 118 then entered the opening of socket 122 for safety ground line 128, placing prong 118 in electrical communication with ground line 128.

Referring now to FIG. 6, when plug 112 is fully inserted into socket 122, insert 100 is compressed between plug 112 and socket 122. Body 102 of insert 100 undergoes elastic deformation, effectively sealing the connection between plug 112 and socket 122 against the intrusion of moisture.

Referring again to FIG. 1, when an outlet cover 12 of an outdoor receptacle 10 is open, moisture in some cases is able to leak into a gap between the outlet 14 and the receptacle 10, creating a risk to the building's electrical system, as well as resulting in possible water damage to the building itself. Accordingly, and referring back to FIG. 6, some embodiments of body 102 of insert 100 are large enough to cover the face of a socket 122.

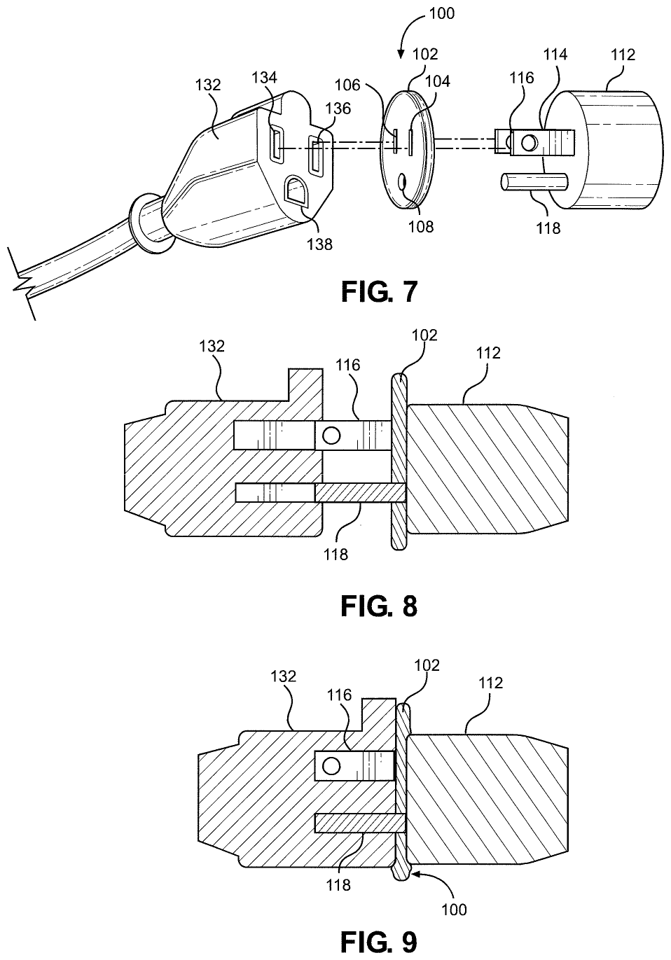

Referring now to FIG. 7, the use of insert 100 to protect a connection between two plugs is illustrated. To use insert 100 to protect an electrical connection between male plug 112 and a female plug 132, prong 114 passes through aperture 104 of insert 100 and enters aperture 134 of female plug 132. As a result, prong 114 is placed in electrical communication with the neutral line of plug 132. Prong 116 passes through aperture 106 of insert 100 and enters aperture 136, placing it in electrical communication with the hot line of plug 132. Likewise, prong 118 passes through aperture 108 of insert 100 and enters aperture 138, placing it in electrical communication with the ground line of plug 132.

Referring now to FIGS. 8 and 9, the elastic deformation of a preferred embodiment of insert 100 between a plug 112 and a power source, shown in FIGS. 8 and 9 as female plug 132, is illustrated. As shown in FIG. 8, prongs 114 (shown in FIG. 7), 116, and 118 pass through the body 102 of insert 100 in order to connect to the power source. A preferred embodiment of insert 100 has a body 102 larger than the face of plug 112, such that it extends past the edges of the face of plug 112, but sufficiently small that it does not interfere with other nearby connections. As an illustration, referring back to FIG. 6, two plugs, each with its own insert 100, could easily be plugged into duplex receptacle 120, since the size of insert 100 is only slightly larger than the face of plug 112 or the face of socket 122.

As shown in FIG. 9, body 102 of insert 100 undergoes elastic deformation when pressed between a plug 112 and a power source. Although female plug 132 is shown as the power source for illustrative purposes, body 102 undergoes a similar deformation with other power sources, such as socket 122 (shown in FIG. 5). The deformation fills in any gaps or pathways through which moisture may enter. Moreover, when body 102 is larger than the face of plug 112, the edge, or the portion of body 102 along the perimeter of body 102, bulges outward around plug 112, further securing the electrical connection against the entry of water.

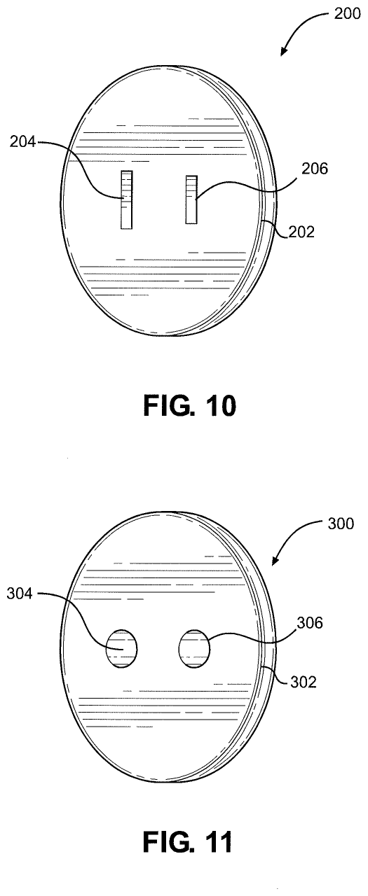

Referring now to FIG. 10, an alternate embodiment of a protective insert for an electrical plug connection is shown and generally designated 200. Insert 200 has a body 202 with two apertures 204 and 206 for a North American style plug without a safety ground prong. As illustrated, aperture 204 is slightly larger than aperture 206 in order to provide a fit tailored to the different sized prongs and socket openings for a hot line and a neutral line. Some older sockets and plugs do not distinguish between hot and neutral lines; accordingly, in some embodiments of insert 200, apertures 204 and 206 are the same size.

Referring now to FIG. 11, another alternate embodiment of a protective insert for an electrical plug is shown and generally designated 300. Insert 300 has a body 302 with apertures 304 and 306 suitable for a plug typical in some European countries. Other embodiments of insert 300 have a number, sizes, shapes, and layout of apertures suitable to the various plug types in use around the world.

Additional embodiments comprising the possible combinations of the various features of the above-described embodiments are also fully contemplated.

While there have been shown what are presently considered to be preferred embodiments of the present invention, it will be apparent to those skilled in the art that various changes and modifications can be made herein without departing from the scope and spirit of the invention.

1. An apparatus for waterproofing an electrical connection, comprising:
an insulating, water-impermeable body comprising two or three apertures,
wherein the apertures are sized and located to allow passage of prongs of an electrical plug through the body to make an electrical connection with a power source,
wherein the body is configured to prevent ingress of water to the electrical connection,
wherein the body comprises a face larger than a face of an electrical plug.

2. The apparatus for waterproofing an electrical connection as recited in claim 1, wherein the power source is a mains power source.

3. The apparatus for waterproofing an electrical connection as recited in claim 1, wherein the body comprises thermoplastic rubber.

4. The apparatus for waterproofing an electrical connection as recited in claim 1, wherein the number of apertures is three.

5. The apparatus for waterproofing an electrical connection as recited in claim 1, wherein the number of apertures is two.

6. The apparatus for waterproofing an electrical connection as recited in claim 1, further comprising an electrical plug having a face and a plurality of prongs, wherein the body is affixed to the face of the electrical plug.

7. The apparatus for waterproofing an electrical connection as recited in claim 1, wherein the body is sufficiently large to cover an electrical socket.

8. The apparatus for waterproofing an electrical connection as recited in claim 1, wherein the face of the body comprises a circular shape.

9. The apparatus for waterproofing an electrical connection as recited in claim 1, wherein the face of the body is configured to undergo an elastic deformation that seals a connection between a plug and a power source.

10. A system for waterproofing an electrical connection, comprising:
a mains power source;
a plug having a plurality of prongs and configured to be received by the mains power source; and
an insert comprising an insulating, water-impermeable body with apertures configured to receive the plurality of prongs of the plug,
wherein the insert is configured to prevent ingress of water to an electrical connection between the plug and the mains power source, and
wherein the body of the insert comprises a circular face larger than a face of the plug.

11. The system for waterproofing an electrical connection as recited in claim 10, wherein the body of the insert comprises thermoplastic rubber.

12. The system for waterproofing an electrical connection as recited in claim 10, wherein the apertures of the body consist of a number of apertures corresponding to a number of prongs of the plug.

13. The system for waterproofing an electrical connection as recited in claim 12, wherein the number of prongs of the plug is three and the number of apertures of the body of the insert is three.

14. The system for waterproofing an electrical connection as recited in claim 10, wherein the body of the insert comprises a flat cylindrical shape.

15. The system for waterproofing an electrical connection as recited in claim 14, wherein the body of the insert is configured to undergo an elastic deformation that seals the connection between the plug and the mains power source.

16. A system for waterproofing an electrical connection, comprising:
A female plug;
a male plug having a plurality of prongs and configured to be received by the female plug; and
an insert comprising an insulating, water-impermeable body with apertures configured to receive the plurality of prongs of the male plug,
wherein the insert is configured to prevent ingress of water to an electrical connection between the male plug and the female plug, and
wherein the body of the insert comprises a circular face larger than a face of the male plug and larger than a face of the female plug.

17. The system for waterproofing an electrical connection as recited in claim 16, wherein the body of the insert comprises thermoplastic rubber.

18. The system for waterproofing an electrical connection as recited in claim 16, wherein the number of prongs of the plug is three and the number of apertures of the body of the insert is three.

19. The system for waterproofing an electrical connection as recited in claim 16, wherein the body of the insert comprises a flat cylindrical shape.

20. The system for waterproofing an electrical connection as recited in claim 19, wherein the body of the insert is configured to undergo an elastic deformation comprising a bulge around the male plug that seals the connection between the male plug and the female plug.
